(19) United States
(12) Patent Application Publication
(10) Pub. No.: US 2024/0143864 A1
(43) Pub. Date: May 2, 2024

(54) APPLICATION OF nD-ROMs ON A RESTRICTED GEOMETRY FOR REAL-TIME TOPOLOGY OPTIMIZATION

(71) Applicant: ANSYS, INC., Canonsburg, PA (US)

(72) Inventors: Dinesh Kumar, Maharashtra (IN); Sebastian Wolff, Wien (AT); Martin Husek, Weimar (DE); Sebastian Stahn, Sehnde (DE)

(21) Appl. No.: 18/163,754

(22) Filed: Feb. 2, 2023

(30) Foreign Application Priority Data
Nov. 2, 2022 (IN) 202241062620

(51) Int. Cl. G06F 30/20; G06F 30/12

(52) U.S. Cl. CPC G06F 30/20; G06F 30/12; G06F 2111/04

(57) ABSTRACT

Embodiments are described of a computer-implemented method. The method receives a geometry of a design space for a design of a physical object based on one or more design parameters and a design objective subjected to design constraints and performs a plurality of topology optimizations according to the design objective to generate two or more structure configurations within the design space of the geometry based on two or more sets of values of the design parameters. Each structure configuration corresponds to a respective set of values of the design parameters. The method then generates a ROM (reduced order model) to predict each of the two or more structure configurations from a corresponding set of the design parameters, receives a separate set of values of the design parameters, and invokes the ROM to predict a target structure configuration within the design space of the geometry from the separate set of values of the design parameters, the target structure configuration for building or manufacturing the physical object.

### CROSS-REFERENCE TO RELATED APPLICATIONS

This application claims foreign priority under 35 U.S.C. § 119(e) to Indian (IN) provisional application No. 202241062620, filed 2 Nov. 2022, the entire contents of which are incorporated herein by reference.

### TECHNICAL FIELD

The disclosed embodiments relate generally to topology optimization and in particular, but not exclusively, to creation and use of a reduced order model (ROM) on a restricted geometry for real-time or near-real-time topology optimization.

### BACKGROUND

Designing the shape or geometry of a mechanical part requires a substantial amount of analysis to account the loads that will be applied to the part, the environment to which it will be exposed (e.g., temperature variations, moisture and chemical exposure, vibration), and design parameters such as the properties of the material used for the part, manufacturing process and its constraints, etc. For a given design scenario the load conditions, environmental conditions, etc., are usually determined by the part's application, so that designing the part's geometry mostly involves considering many different sets of parameters. Every design need not consider sets of every possible material property; an experienced design engineer can usually pick a set of material properties that are important for a particular part in a particular application.

In some applications—e.g., weight-sensitive applications such as aircraft and automotive etc.—the part's geometry must be optimized so that it performs as needed under the expected loads and environmental conditions while meeting certain constraints, such as minimizing the amount of material used, maintaining enough strength and stiffness, cost and manufacturing aspects etc. Conventional optimization starts with selecting a starting geometry and analyzing many different sets of parameters on the starting geometry. Once the starting shape is analyzed, optimization then involves multiple iterations of: (i) modifying the shape based on the analysis and (ii) re-analyzing the modified shape, and (iii) further modifying the shape. Iteration through these steps continues until an optimum structure which satisfies all above mentioned objectives and constraints, is determined.

Normally a part geometry, a set of applied loads, material properties and a set of parameters are inputs to the FEM to calculate what response in terms of stresses, strains, deformations or other scalar quantities, the applied loads and environmental conditions will generate. And for that calculated response, topology optimization would predict an optimum shape, which is optimum only for the given set of input values. But when the conditions or input values are varied, another FEM topology optimization would be needed to get another optimized geometry to meet the modified conditions or input values.

However, a design may depend on more than one single set of requirements, “variability” in the requirements, and/or requirements driven by different disciplines, considerations of multiple design objectives (or design optimizations) and/or tradeoffs among conflicting design objectives. A single topology optimization can address only a limited set of requirements. Therefore, performing multiple topology optimizations or holistic optimizations may be required to take care of the variability and multidisciplinary nature of the requirements, a separate FEM topology optimization for each parameter set. Each FEM topology optimization run is time-consuming and computationally intensive, making it difficult to use quickly and economically as an optimizing tool.

### BRIEF DESCRIPTION OF THE DRAWINGS

Non-limiting and non-exhaustive embodiments of the present invention are described with reference to the following figures, in which like reference numerals refer to like parts throughout the various views unless otherwise specified.

FIG. 1 is a diagram of an embodiment of a method for creating a reduced order model (ROM) and using it for real-time topology optimization.

FIGS. 2A-2B are diagrams of an embodiment of a design of experiment (DoE) method.

FIG. 3 is a diagram of an embodiment of a method for creating topology optimization data from which to build a ROM.

FIG. 4 is a diagram of an embodiment of a method for creating a ROM using topology optimization data.

FIGS. 5A-5B are diagrams of an embodiment of the use of a ROM by a user through a user interface.

FIG. 5C is a graph of embodiments of processes by which a user can employ an ROM to create a design.

FIG. 6 is a diagram of an embodiment of the use of a ROM to output an optimized scalar topology field corresponding to a set of design parameter values input to the ROM.

FIG. 7 is a diagram of an embodiment of the use of a geometric operator to extract a geometry from an optimized scalar topology field.

FIG. 8 is a diagram of an embodiment of building or manufacturing the geometry extracted in FIG. 7 into a physical object.

FIG. 9 is a block diagram of an embodiment of a data processing apparatus.

FIG. 10 is a block diagram of an embodiment of a system that can be used to implement the methods described herein.

FIGS. 11A-11C are block diagrams of embodiments of systems that can be used to implement the methods described herein.

### SUMMARY

In one aspect, a non-transitory machine-readable medium storing executable instructions which when executed by a data processing system cause the data processing system to perform a method. The method includes receiving a geometry of a design space for a design of a physical object based on one or more design parameters and a design objective, and performing a plurality of topology optimizations according to the design objective to generate two or more structure configurations within the design space of the geometry based on two or more sets of values of the design parameters, each structure configuration corresponding to a respective set of values of the design parameters. The method further includes generating a ROM (reduced order model) to predict, forecast, or interpolate each of the two or more structure configurations from a corresponding set of the design parameters, receiving a separate set of values of the design parameters, and invoking the ROM to predict, forecast, or interpolate a target structure configuration within the design space of the geometry from the given set of values of the design parameters, the target structure configuration for building or manufacturing the physical object. An alternative structure configuration can be predicted by invoking the ROM within the design space of the geometry from an alternative set of values of the design parameters. The target structure configuration can be selected for building or manufacturing the physical object.

In an embodiment the geometry of the design space is fixed. In another embodiment the target structure configuration is obtained by applying a geometric operator to an optimized topology field predicted by the ROM. In an embodiment, applying the geometric operator comprises thresholding the optimized topology field to eliminate values of a scalar field for example density/distance field, that are outside a specified range, and extracting the target structure configuration from the design space using the thresholded topology scalar field. In an embodiment, extracting the target structure configuration comprises subtracting from the design space parts of the geometry where the topology scalar field is outside the specified range.

In an embodiment the ROM receives the separate set of values of the design parameters from a user interface. In another embodiment the method further comprises displaying the optimized topology, the target structure configuration, or both, to a user via the user interface. In still another embodiment the two or more sets of values of the design parameters used for the topology optimizations are selected using a design of experiment (DoE) method. In yet another embodiment, the DoE method is a stochastic type of method like Latin Hypercube method or a space filling method, or is a deterministic kind of method like factorial or central composite design.

In another aspect, a computer-implemented method receives a geometry of a design space for a design of a physical object based on one or more design parameters and a design objective and performs a plurality of topology optimizations according to the design objective to generate two or more structure configurations within the design space of the geometry based on two or more sets of values of the design parameters. Each structure configuration corresponds to a respective set of values of the design parameters. The method then generates a ROM (reduced order model) to predict each of the two or more structure configurations from a corresponding set of the design parameters, receives a separate set of values of the design parameters; and invokes the ROM to predict a target structure configuration within the design space of the geometry from the separate set of values of the design parameters, the target structure configuration for building or manufacturing the physical object. An alternative structure configuration can be predicted by invoking the ROM within the design space of the geometry from an alternative set of values of the design parameters. The target structure configuration can be selected for building or manufacturing the physical object.

In an embodiment the geometry of the design space is fixed. In another embodiment the target structure configuration is obtained by applying a geometric operator to an optimized topology predicted by the ROM. In an embodiment, applying the geometric operator comprises thresholding the optimized topology to eliminate values of a topology scalar field that are outside a specified range, and extracting the target structure configuration from the design space using the thresholded topology scalar field. In an embodiment, extracting the target structure configuration comprises subtracting from the design space parts of the geometry where the topology scalar field is outside the specified range.

In an embodiment the ROM receives the separate set of values of the design parameters from a user interface. In another embodiment the method further comprises displaying the optimized topology, the target structure configuration, or both, to a user via the user interface. In still another embodiment the two or more sets of values of the design parameters used for the topology optimizations are selected using a design of experiment (DoE) method. In yet another embodiment, the DoE method is a stochastic type like Latin Hypercube method or a space filling method, or is a deterministic kind of method like factorial or central composite design.

### DETAILED DESCRIPTION

Embodiments are described of a system and method creating an n-dimensional reduced order model (nD-ROM) and using the nD-ROM for real-time or near-real-time topology optimization. Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless encompassed within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the particular features, structures, or characteristics may be combined in any suitable manner in one or more embodiments.

The terms shape and geometry are used interchangeably in this description. There is some overlap in their meanings, but they are slightly different. “Shape” mainly refers to what is predicted by topology optimization/nD-ROM, while “geometry” indicates the workable computer-aided design (CAD) model produced referring to the shape predicted, or the initial geometry before the optimization (which is fixed). In other words, a shape represents geometry in its implicit form, e.g. as a point cloud where each point has a certain value, while geometry is an explicit representation of a shape in the form of edges, surfaces, and solids. Although used interchangeably in the description, the precise meaning should be clear from the context.

The disclosed embodiments, instead of requiring a separate FEM run for each set of parameter values, use a limited number of FEM topology optimization runs. Each FEM topology optimization run is executed on many design points determined with a Design of Experiment (DoE) method, where each design point includes a different set of values of the N design parameters.

The FEM topology optimization determines an optimized scalar topology field for each design point which implicitly represents the optimized geometry. Having executed the FEM topology optimization runs under a DoE scheme, by using all design points, an n-dimensional reduced order model (nD-ROM) of the optimized scalar topology fields is created. The nD-ROM can then be used in real-time or near-real-time creation of optimized topologies for different values of each the N design parameters—that is, different combinations of design parameter values, even value combinations that were not among the limited number of design points, so that a designer can quickly explore many possible combinations to arrive at one to be built of manufactured as a physical object.

To extract an optimized geometry from the shape implied by the optimized topology scalar field, a geometric operator is applied to “threshold” the optimized scalar topology field for the set of design parameters values used by the nD-ROM model. Thresholding involves subtracting parts of the fixed initial geometry where the scalar topology field falls outside (above or below) certain values. By doing this, regions of the initial geometry (also referred to as the design space) that are not needed are removed, thus optimizing the resulting geometry.

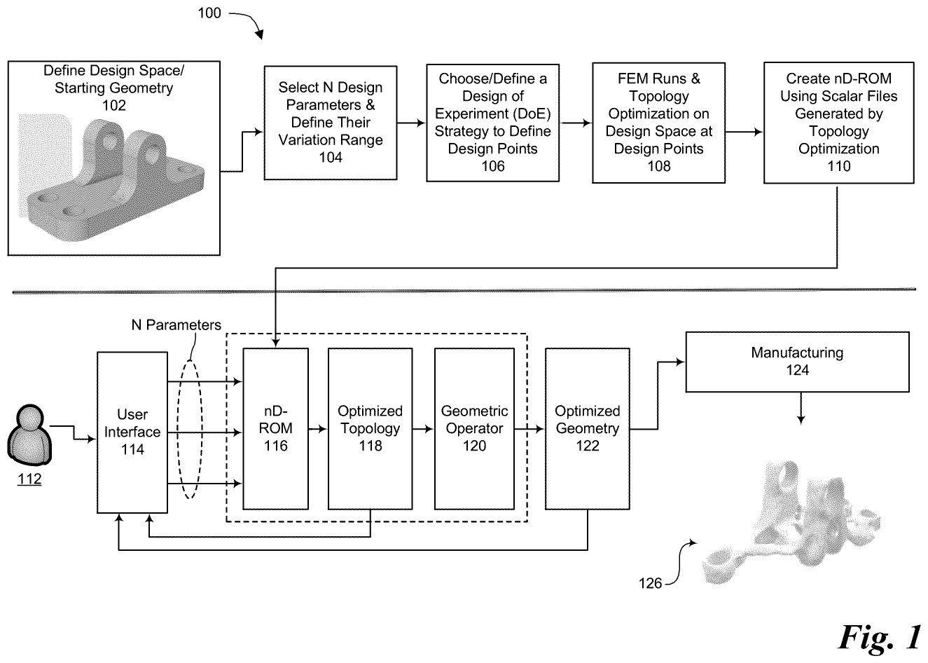

FIG. 1 illustrates an embodiment of a process 100 for topology optimization. Blocks 102-110, the figure's top half, illustrate steps used in this embodiment to create an n-dimensional reduced order model (nD-ROM) 116. Blocks 112-126, the figure's bottom half, illustrate an embodiment of the nD-ROM's use by a designer for topology and geometry optimization. The processes of the individual blocks, or groups of them, are described in more detail below.

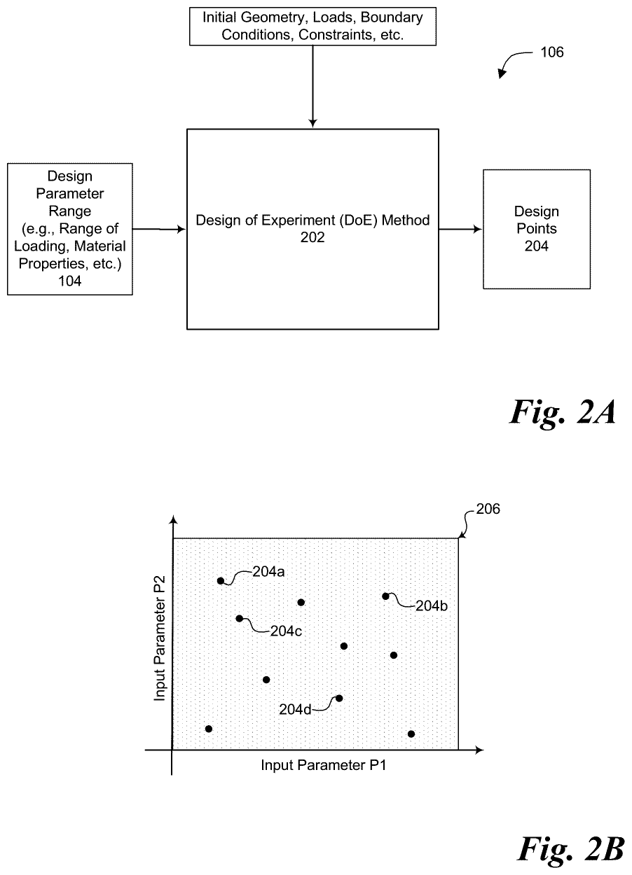

Process 100 begins with the definition of an initial geometry 102, also referred to as the design space, of a part to be manufactured. The design space is fixed (does not change) throughout the process. At block 104, a set of N design parameters relevant to the part design is selected; relevant design parameters can include material properties, thermal properties, loading, boundary conditions, topology optimization constraints, etc. At block 106, a design of experiment (DoE) process is applied to the design space and the values of each of the N design parameters to produce a set of design points, where each design point is a set of values of the N design parameters (see FIGS. 2A-2B).

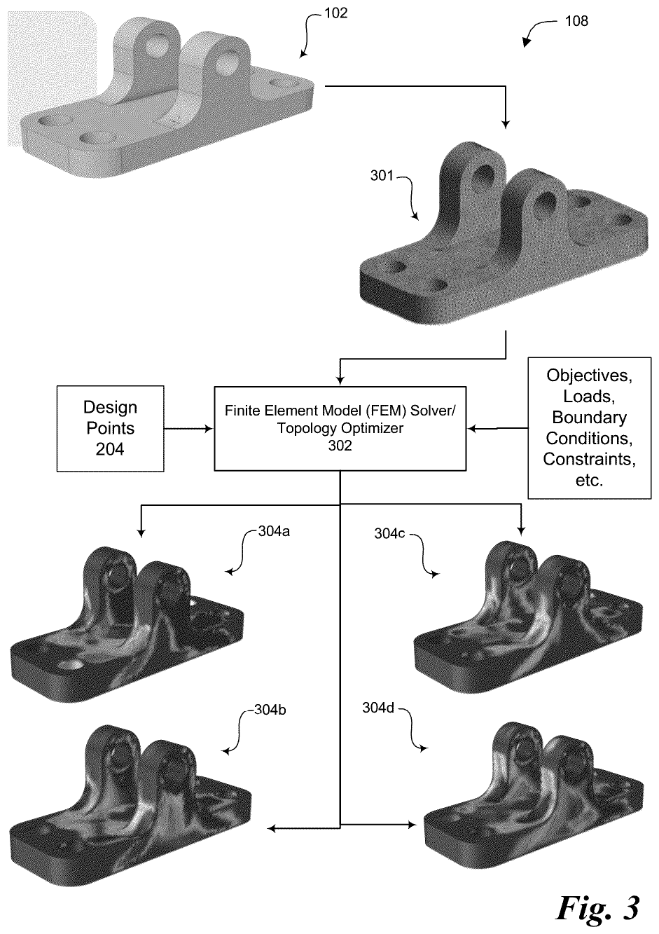

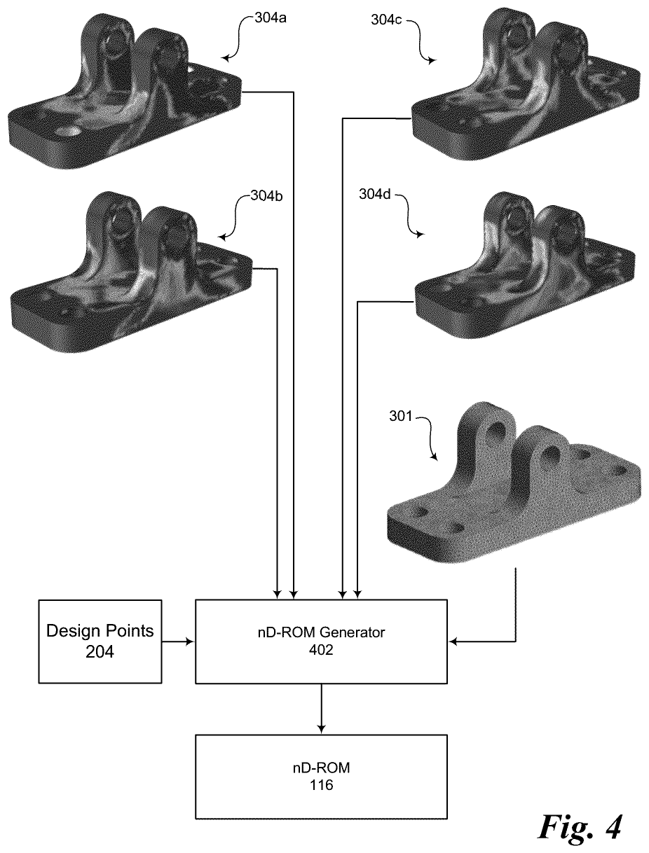

At block 108, a finite element method (FEM) code is used to run a topology optimization for each design point. The current embodiment is illustrated using FEM, but other embodiments can include any numerical methods over which a topology optimization algorithm can run to create a topologically optimized geometry. Numerical methods that can be used to solve a physical problem, such as the Finite Element Method (FEM) of mesh-based methods, Smoothed Particle Hydrodynamics (SPH) of meshfree methods, etc., are computational methods that can be used for topology optimization. An FEM analysis is generally set up before a topological optimization because the topology optimization algorithms use FEM results to obtain scalar fields which implicitly represent optimized shape. The FEM topology optimizations generate, for each design point, a scalar topology field on the starting geometry (see FIG. 3). At block 110 the starting geometry (i.e., the design space), the design points, and their corresponding topology fields, among other things, are used to create n-dimensional nD-ROM 116 (see FIG. 4).

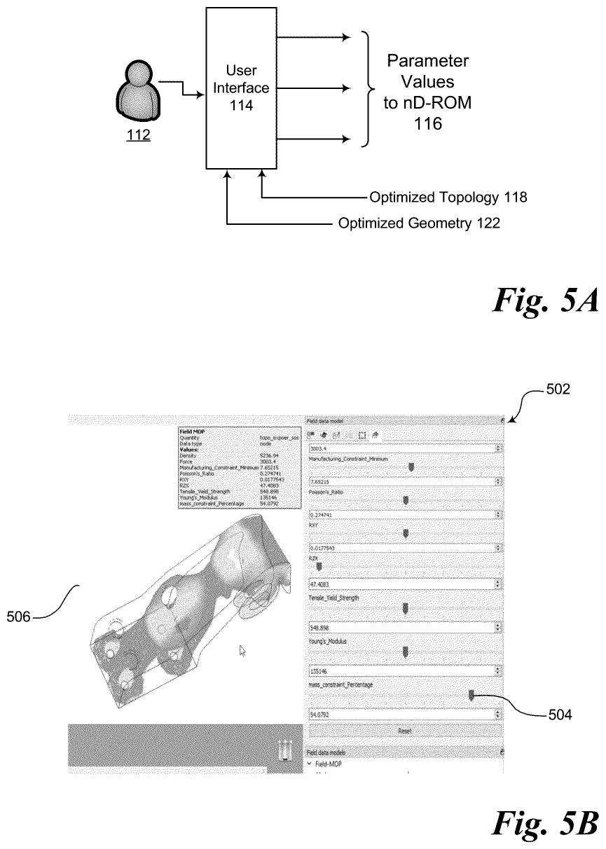

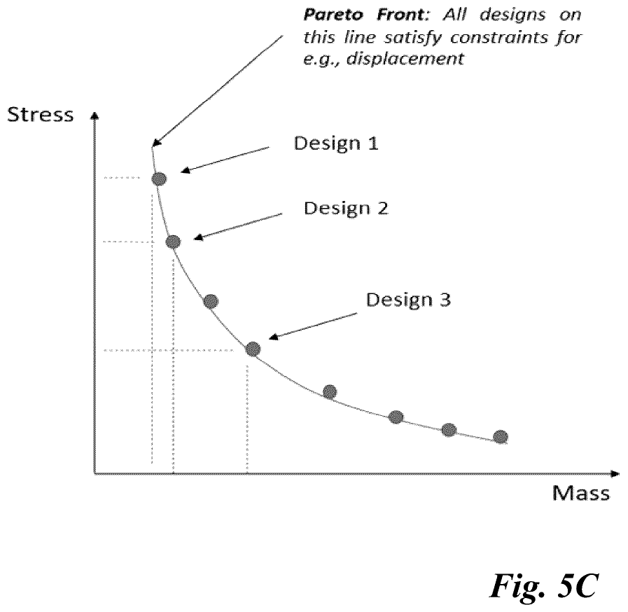

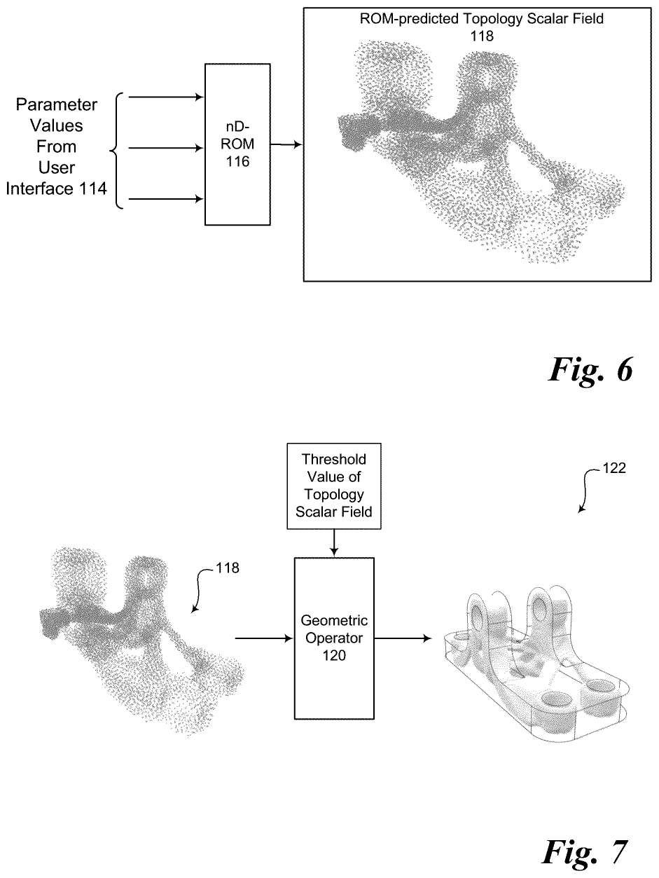

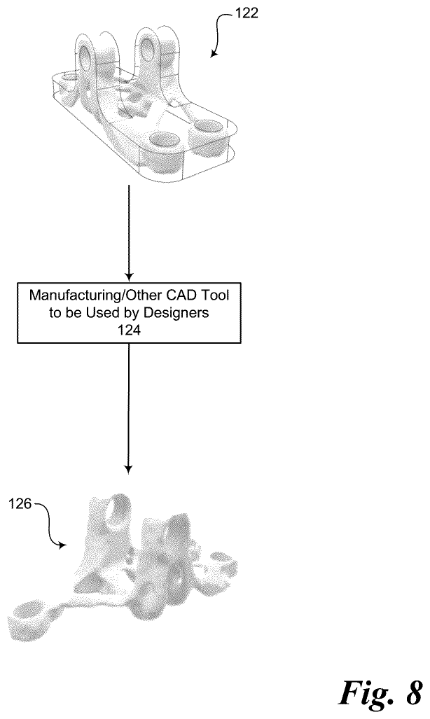

After nD-ROM 116 is created at block 110, it can be used by a user 112, such as an engineer or designer, to evaluate optimized topologies for any set of values of the N design parameters. nD-ROM 116 is much faster than the FEM runs at block 108, so that nD-ROM produces optimized topologies in real time or near-real-time. User 112 interacts with a user interface 114, which passes design parameter values to nD-ROM 116 (see FIG. 5). As it receives design parameter values from user interface 114, nD-ROM 116 outputs an optimized scalar topology field 118 corresponding to the set of design parameter values, which are then input to a geometric operator 120 that extracts the optimized geometry 122 that is implied by optimized scalar topology fields (see FIGS. 6-7). User interface 114 can also display optimized topologies and geometries (see FIG. 5). In one embodiment nD-ROM 116 and the geometric operator 120 can be put together in a single software package, but in other embodiments they need not be. Optimized geometry 122 can then be transmitted to a manufacturing facility 124 to be manufactured into a physical part 126.

In one embodiment, process 100 can receive multiple sets of inputs (or values of design parameters) for designing/manufacturing a physical object, and generate a separate optimized shape for each set of inputs, e.g. by invoking nD-ROM 116. For example, process 100 can receive objectives and/or constraints for designing the physical object (e.g. via the user interface) to perform a multi-objective multidisciplinary nonlinear optimizer driven by an AI (artificial intelligence) algorithm or other applicable algorithms on multiple optimal shapes generated via nD-ROM 116. The nonlinear optimizer and nD-ROM can allow exploration of different values of design parameters according to various objectives/constraints to finalize a design for the physical object.

In some embodiments, one of the generated optimized shapes (or geometries) by nD-ROM 116 can be selected as a final design of the physical object for manufacturing. The selection can include an evaluation and/or comparison of the optimized shapes generated by nD-ROM 116 according to additional design considerations (e.g. other than those included in the design parameters for topology optimization). Invocation of nD-ROM 116 to generate optimized shapes and evaluations of these generated shapes may be performed iteratively before arriving at the final design. In certain embodiments, a relationship exposing potential tradeoffs or compromises among the generated optimized shapes can be presented via the user interface before receiving a selection of an optimized shape for manufacturing the physical object. Alternatively or optionally, the selection can include presenting the generated optimized shapes via a user interface and receiving a user interface instruction to identify the final design.

FIGS. 2A-2B together illustrate an embodiment of a design of experiment as shown in block 106 of FIG. 1. FIG. 2A illustrates an embodiment of the basic process flow: N design parameters 104 are entered into a design of experiment (DoE) method 202 along with other quantities like the fixed initial geometry 102, loads, boundary conditions, constraints, and so on. In one embodiment DoE method 202 can be a stochastic DoE scheme like a Latin Hypercube method or a space filling method, but other embodiments can use a deterministic DoE schemes like factorial or central composite design.

Computer programs that implement DoE methods are commercially available. Using these inputs, DoE method 202 outputs a series of design points 204, each of which is a combination of particular values of the N design parameters. Using a DoE method to select design points ensures the quality of the resulting ROM for accurate predictions of topology scalar fields, as measured by metrics such as the Field Coefficient of Prognosis (FCoP), which should generally exceed 90%, and the explained variation, which should generally exceed 95%.

FIG. 2B illustrates an embodiment of design points for a two-dimensional parameter space—that is, a space where N=2, meaning there are two design parameters P1 and P2. In the illustrated embodiment N=2 is chosen for ease of illustration; in other embodiments N can be any integer greater than 0. Design parameters P1 and P2 each have a value range, so that the value ranges of the two design parameters form the boundaries of a parameter space 206, shown shaded in the figure. DoE 202 outputs design points 204 that are within parameter space 206 of P1 and P2. The illustrated embodiment has ten design points 204 (only four of which are labeled for later discussion), but other embodiments can have more or less design points than shown depending upon the value of N, parameter ranges and the problem solved. Because in the illustrated embodiment N=2, each design point 204 includes a different pair of values of design parameters P1 and P2, but in other embodiments where N 2 each design point would represent a set of N design parameter values, with one value for each of N design parameters. For instance, in an eight-dimensional design parameter space (N=8), each design point 204 would include a set of eight design parameter values.

Using the DoE results in design points 204 that will allow the resulting nD-ROM to quickly calculate optimized topologies for any point in parameter space 206 (i.e., any set of design parameter values in the parameter space), even for points in the parameter space that were not design points 204. Design parameters that can be used to create the ROM and can later input into the ROM include:
Material: Young's modulus, Poisson's ratio, density, yield strength, thermal conductivity, contact stiffness, spring/joint stiffness, coefficient of thermal expansion, specific heat, material damping, ultimate strength, fatigue endurance limit, thermal emissivity.
Loading: magnitude, direction, frequency of load, concentrated loads, pressure, temperature, inertia load, heat flux, convection coefficient, radiation, bearing loads, spring/joint loads and other loads.
Boundary Conditions: specified displacements, rotations, temperatures, magnitude and orientations, convection, radiation.
Response constraints: frequency, displacement, stress, temperature, compliance, strain energy, user defined criteria, mass/volume fraction, CG Location, inertia, reaction forces, user defined manipulated constraints like natural frequency gap between modes.
Manufacturing Constraints: member size, overhang angle, pull out and extrusion direction, gap, cyclic sectors, repetitions, symmetry axis, gap size.

FIG. 3 illustrates an embodiment of the process of block 108 (see FIG. 1) for generating topology optimization data that can be used to create and train an nD-ROM model. Fixed initial geometry 102 is first converted into a discretized representation 301, sometimes referred to as a mesh, that consists of numerous discrete finite elements that will be used for calculation in finite element method (FEM) topology optimizations. Discretized representation 301, together with design points 204 and other quantities such as objectives, loads, boundary conditions, etc., are input into FEM topology optimizer 302.

FEM topology optimizer 302 performs a topology optimization on initial geometry 102. One embodiment FEM topology optimizer 302 can use a SIP method, but other embodiments can use different methods, such as a Level-Set method. Generally, topology optimization is a mathematical method that optimizes material layout within a given design space—in this case, the design space/fixed initial geometry 102—for a given set of loads, boundary conditions and constraints with the goal of maximizing the performance of the system based on an objective function. In general form, topology optimization can be written mathematically as:

minimize ρ in F=F(u(ρ),ρ)=∫_{Ω}f(u(ρ),ρ)dV

subject to:

G₀(ρ)=∫_{Ω}ρdV−V₀≤0

withGⱼ(u(ρ),ρ)≤0,j=1, . . . m.

The objective F(u(ρ),ρ) represents the quantity that is being optimized (e.g., minimized) for best performance. A common objective function is compliance, where minimizing compliance leads to maximizing the structural stiffness, but other embodiments can use other objective functions for example minimizing mass, maximizing frequency, minimizing thermal compliance etc. ρ represent the material distribution as a scalar topology density of the material at each location: its value varies continuously between 0 and 1, with presence of material indicated by a 1 and a complete absence of material indicated by a 0. The design space Q indicates the allowable volume within which the topologically optimized design can exist—i.e., the fixed initial geometry. Regions or components in the model within the design space that cannot be modified during optimization are considered non-design regions. Assembly and packaging requirements and tool accessibility are some factors that can be considered when identifying the design space. Usually design space Q is fully contained within fixed initial geometry 102.

For each design point 204, and for a particular objective and set of loads, boundary conditions, constraints, etc., FEM topology optimizer 302 outputs a scalar field distribution that implicitly represents the geometry. The scalar field distribution describes an optimized topology, shown as topology field 304 within the design space (i.e., within the fixed initial geometry), and there is a one-to-one correspondence between design points and output scalar fields. Topology fields 304, as described above, are scalar fields of ρ. Thus, in the illustrated embodiment FEM topology optimizer 302 outputs a scalar field 304a corresponding to design point 204a, a scalar field 304b corresponding to design point 204b, and so on for all design points 204. The scalar field distribution can be a topology density field ρ for a SIMP method, but can be a distance field for a Level-Set method and similarly any field from any of the numerical methods which is an output of the topological optimization algorithm, represents the geometry implicitly.

FIG. 4 illustrates an embodiment of the process of block 110 (see FIG. 1) for creating n-dimensional reduced order model (nD-ROM) 116. The dimensionality (n) of the nD-ROM is independent from the number N of design parameters corresponding to each design point 204 described above. Put differently, the dimensionality n of the nD-ROM is independent from the dimensionality N of the design parameter space described above. The nD-ROM is created by inputting discretized initial geometry 301, along with design points 204 and their corresponding scalar field for example density fields 304, into nD-ROM generator 402. nD-ROM generator 402 is generally a software package that uses model order reduction (MOR) to creates a corresponding nD-ROM 116. Model order reduction (MOR) is a technique for reducing the computational complexity of mathematical models in numerical simulations. As such, it is closely related to the concept of metamodeling. For physical simulation models, model order reduction or reduced order modelling (ROM) are more commonly used than the term “meta-modeling.” A classical meta model (or ROM) typically approximates a single quantity. For example, a scalar response value of a mathematical function (a maximum physical stress, a displacement, a temperature, etc.) is an output of zero-dimensional (OD) models. nD-ROMs can refer to ROMs suitable for approximating higher-dimensional fields like time series (TD), spatially distributed data (3D), or combinations of both. nD-ROM can be directly used to approximate an entire field of mechanical stresses, to be used in, for example, visualization, etc. Packages for creating nD-ROMs are commercially available; examples include the optiSlang and Model Center platforms produced by Ansys, Inc., of Canonsburg, Pennsylvania, USA.

Invoking ROMs does not involve performing FEM topology optimizations or simulations. An FEM topology optimization can, for example, be performed based on a gradient based optimization algorithm or any method which operates over the FEM solution. FEM topology optimization can use a finite element analysis (FEA) solution, iterate over it to meet defined objective and constraints, and eventually output a field of some scalar variable (e.g., topology density). nD-ROM, however, uses techniques to predict an unknown topology optimization solution from the known solutions, for example, by interpolating/extrapolating the known solutions without performing simulation nor conducting an FEA analysis. The known solutions are obtained from FEM topology optimizations by using a DoE strategy.

FIGS. 5A-5B illustrate embodiments of user interaction with nD-ROM 116 after its creation. FIG. 5A illustrates an embodiment of the interaction of a user 112, such as an engineer or designer, with user-interface 114. User 112, interacting with user-interface 114, can vary the values of design parameters and send a separate set of those design parameter values to the nD-ROM—i.e., the set of design parameter values sent to nD-ROM 116 by the user interface can be a set of design parameter values separate from the ones input to FEM optimizer 302 (FIG. 3)—but, the design parameters whose value can be varied in the user interface will correspond to the design parameters used for design points 204. For instance, in the two-parameter (i.e., N=2) embodiment of FIGS. 2A-2B each design point represents a set of two design parameter values, P1 and P2, and user interface 114 can be used to vary the values P1 and P2 over the entire parameter space 206, and send those values of P1 and P2 to nD-ROM 116. In other embodiments the values of less than all the design parameters can be varied, for instance by fixing the values of some design parameters but allowing variation of the values of others.

In response to a combination of design parameter values received from the user interface, nD-ROM 116 generates an optimized topology scalar field for that particular set of design parameter values. The optimized topology, which in one embodiment is represented as scalar field as described above, can then be fed back to user interface 114 to provide user 112 with a graphic rendering of the optimized topology for that set of values. As described below, the optimized topology can be converted into an optimized geometry, and the optimized geometry can also be fed back to the user interface to produce a graphic rendering of the optimized geometry.

FIG. 5B illustrates an embodiment of a user interface 502 through which a user can interact with nD-ROM 116. In the illustrated embodiment the right side of user interface 502 includes seven sliders 504. Each slider 504 corresponding to a design parameter whose value can be input to the nD-ROM, and each slider is labeled with the name of its corresponding design parameter. Other embodiments can, of course, include a different number of sliders; generally, the number of sliders 504 will correspond to the number of design parameters used to create the nD-ROM. Each slider 504 covers the range of possible values for the design parameter it represents, and a user can change the value of a design parameter by moving the appropriate slider. The current value of each design parameter is indicated in the box above the slider. As the design parameters are varied with the slider, the optimized topology and optimized geometry for the current slider positions can be displayed in a window 506 on the left side of the user interface, so the designer can see the results of the optimization for the selected design parameter values. Because nD-ROM 116 can quickly determine optimum topologies, display of the optimized topology and/or optimized geometry can happen in real time or near-real time in response to movement of the sliders.

The input variables (or design parameters) can be changed to generate a new nD-ROM to obtain an optimized shape for a given set of inputs (or values of design parameters) to allow the user the freedom to vary the input values of the design parameters to get another optimum shape efficiently. The method can enable a user to choose or determine the best shape for a physical object design out of all the shapes generated by the nD-ROM. For instance, the best shape or geometry can be selected by either (i) manually choosing/tweaking the inputs for “trial and error” evaluation, which can be done quickly with nD-ROM 116, or (ii) using/exposing the nD-ROM in an AI based multi-objective multidisciplinary nonlinear optimizer which creates multiple shapes driven by an AI algorithm based on the objectives and constraints (e.g. defined by a user) with the best shape eventually selected based on a tradeoff study or evaluation.

FIG. 5C illustrates an example of embodiments of a tradeoff design study in case of multi-objective problem for which nD-ROM 116 is employed to create a design. “Trial and error” can include a process to receive the design inputs tweaked or varied by a user; generate design outputs (e.g. with topologically optimized shapes); check or evaluate if the output meets expectations; and, if not, repeat the process. This selection process can involve human intervention for choosing the best design as per their expectations. Use of embodiments of an nD-ROM as described above allows users to reduce the time of each iteration of this trial-and-error process by quickly creating a design shape using ROM.

In other embodiments, if an engineer is unable to get a satisfactory design(s) manually, which could be due to many possibilities of best designs, objectives conflict, etc., then the “trial and error” process can be performed based on AI techniques. For example, design objective and constraints can be defined (e.g. received from a user interface) for an AI-based optimizer to explore the design possibilities. The solver behind the AI would be an embodiment of the nD-ROM generated as described above. If the design problem involves a single objective, for example just minimize mass, stresses should be less than 100 MPa and deformation less than 1 mm, the AI can provide a single final best design output. On other hand, if the design problem involves multi-objective, and has conflicting objectives like minimizing mass, minimizing stress, and keeping deformation less than 1 mm, the AI would give a list of best candidate designs to allow a compromise or tradeoff received from a user. This list is referred to in FIG. 5C as a “Pareto Front.”

For example, in FIG. 5C the user can choose, depending on the scenario at hand, whether design 1 (high stress but lesser mass) is good or design 3 (comparatively more mass but less stress) is better. This part of the selection process is mostly manual. The nD-ROM embodiments described above accelerate the design creation process, whether it is manual or AI; because it is a ROM, it can be easily and quickly operated and can be easily exposed to AI tools like optiSLang, Model Center, etc.

FIG. 6 illustrates an embodiment of the process of blocks 116 and 118 (see FIG. 1) for creating an optimized topology. As nD-ROM 116 receives design parameter values from user interface 114, it applies its model to the particular set of design parameter values received from the user interface to generate an optimized topology 118. In one embodiment, optimized topology 118 can be output from the nD-ROM as a field of scalar densities ρ, as discussed above. In the illustrated embodiment, optimized topology 118 is an optimized topology corresponding to, and based on, fixed initial geometry 102 i.e., it corresponds to and is based on the design space.

FIG. 7 illustrates an embodiment of the process of blocks 120 (see FIG. 1) converting an optimized topology into an optimized geometry, which is a target structure configuration that can be built or manufactured as a physical object. In an embodiment where optimized topology 118 is output from nD-ROM as a topology field ρ, the optimized scalar field ρ implies an optimized geometry. To extract the optimized geometry implied by the optimized topology field, optimized topology field 118 is input to a geometric operator 120, along with the set of design parameter values that resulted in that optimized topology.

Geometric operator 120 then extracts the optimized geometry 122 that is implied by optimized topology 118. In one embodiment the geometric operator extracts optimized geometry 122 by thresholding the scalar field ρ to extract values of ρ that fall within a desired range. Then, based on the thresholding, geometric operator 120 subtracts parts of the geometry where the scalar field falls outside the desired range. For instance, if ρ has values in a range between 0 and 1, thresholding can find where ρ has values between 0.3 and 1 and identify those locations in the initial geometry (i.e., the design space). Any parts of the geometry where ρ falls outside this range—i.e., where ρ is less than 0.3 in this example—are subtracted from the initial geometry to create an isosurface that represents the optimized geometry. Other embodiments can, of course, use other methods to extract the optimized geometry from the optimized topology.

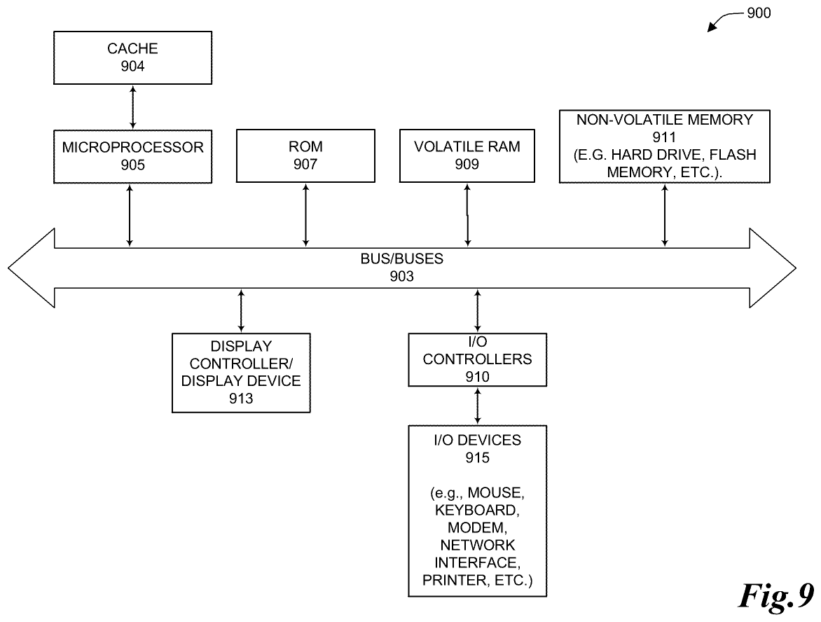

FIG. 8 illustrates an embodiment of the process of block 124 (see FIG. 1) for building or manufacturing a physical part from the optimized geometry. Once an optimized geometry 122 is determined, it can be output in a form that can be sent to a manufacturing facility 124, or as a CAD geometry to the designers for further use in product development cycle. In one embodiment the output can be electronic, such as a computer aided design (CAD) file that can be used directly by computer-controlled manufacturing machines, but in other embodiments the output can be a paper printout such as a blueprint or other drawings. However the output is provided, it is sent to manufacturing facility 124, which can then be build or manufacture a physical part 126 having optimized geometry 122.

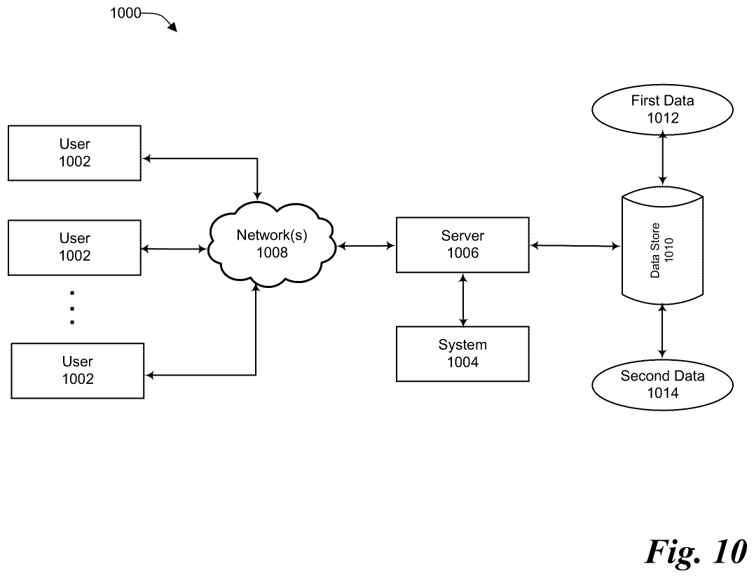

FIG. 9 illustrates an embodiment of a data processing system 900. System 900 can be used to perform any of the methods described above. Thus, system 900 is an example of a simulation system that can execute the methods described herein. Although FIG. 9 illustrates the components of a data processing device, it is not intended to represent any particular architecture or way of interconnecting the components, because such details are not germane to the disclosure. It will also be appreciated that network computers and other data processing systems or other consumer electronic devices, which have fewer components or perhaps more components, can also be used with the disclosed embodiments.

System 900 is a data processing system that includes a bus 903 coupled to a microprocessor(s) 905, a ROM (Read Only Memory) 907, volatile RAM 909, and a non-volatile memory 911. Microprocessor(s) 905 can retrieve instructions from memories 907, 909, and 911 and execute the instructions to perform operations described above. Microprocessor(s) 905 can contain one or more processing cores. Bus 903 interconnects these various components together and also interconnects components 905, 907, 909, and 911 to a display controller and display device 913 and to peripheral devices such as input/output (I/O) devices 915 which can be touchscreens, mice, keyboards, modems, network interfaces, printers and other devices known in the art. Typically, input/output devices 915 are coupled to the system through input/output controllers 910.

Volatile RAM (Random Access Memory) 909 is typically implemented as dynamic RAM (DRAM), which requires continual power to refresh or maintain the data in the memory. Non-volatile memory 911 is typically a magnetic hard drive, a magnetic optical drive, an optical drive, a DVD RAM, a flash memory, or other types of memory systems that maintain data (e.g., large amounts of data) even after power is removed from the system. Typically, non-volatile memory 911 will also be a random-access memory, but this is not required. While FIG. 9 shows that non-volatile memory 911 is a local device coupled directly to the rest of the components in the data processing system, other embodiments can utilize a non-volatile memory which is remote from the system, such as a network storage device which is coupled to the data processing system through a network interface such as a modem, an Ethernet interface, or a wireless network. Bus 903 can include one or more buses connected to each other through various bridges, controllers, and/or adapters as is well known in the art.

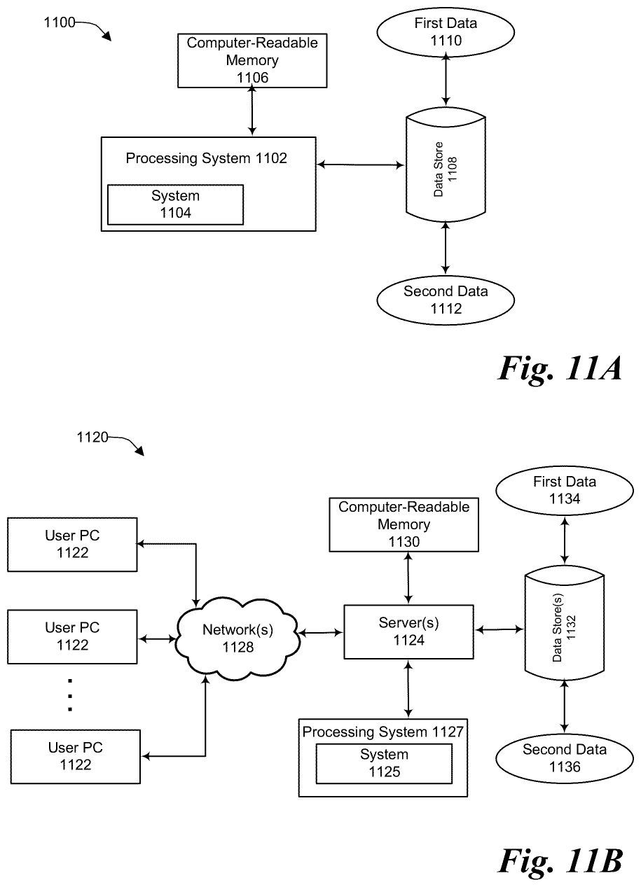

FIG. 10 illustrates a computer-implemented environment 1000 in which users 1002 can interact with a system 1004 hosted on one or more servers 1006 through a network 1008. System 1004 contains software operations or routines. Users 1002 can interact with system 1004 in a number of ways, such as over one or more networks 1008. One or more servers 1006 accessible through network(s) 1008 can host system 1004. It should be understood that system 1004 could also be provided on a stand-alone computer for access by a user.

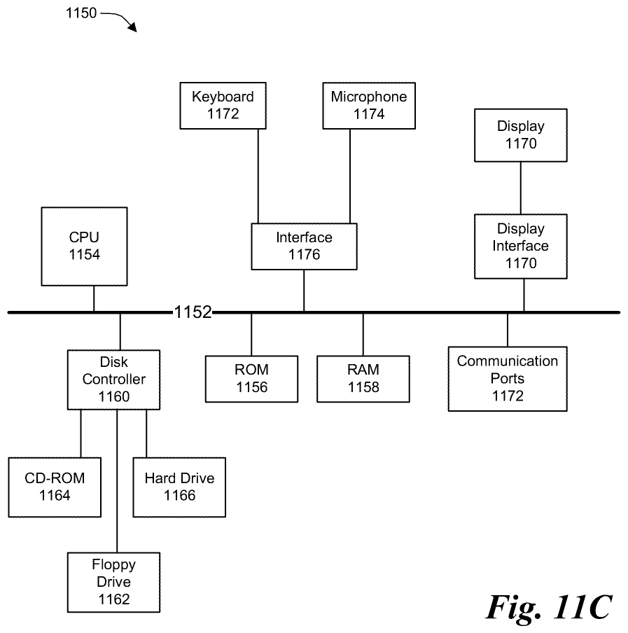

FIGS. 11A-11C illustrate embodiments of systems for implementing the methods described above. FIG. 11A illustrates an embodiment of a system 1100 that includes a standalone computer architecture where a processing system 1102 (e.g., one or more computer processors located in a given computer or in multiple computers that can be separate and distinct from one another) includes a system 1104 (e.g., FEM optimizer) being executed on it. Processing system 1102 has access to a non-transitory computer-readable memory 1106 in addition to one or more data stores 1108. The one or more data stores 1108 can contain first data 210 (e.g., DoE method) as well as second data 212 (e.g., ROM generator). Processing system 1102 can be a distributed parallel computing environment, which can be used to handle very large-scale data sets.

FIG. 11B illustrates an embodiment of a system 1120 that includes a client-server architecture. One or more user PCs 1122 accesses one or more servers 1124 running a system 1125 (e.g., FEM optimizer) on a processing system 1127 via one or more networks 1128. The one or more servers 1124 can access a non-transitory computer readable memory 1130 as well as one or more data stores 1132. The one or more data stores 1132 can contain first data 234 (e.g., DoE method) as well as second data 236 (e.g., ROM generator).

FIG. 11C illustrates an embodiment of hardware for a standalone computer architecture 1150, such as the architecture of FIG. 11A, that can be used to contain and/or implement the disclosed methods. A bus 1152 can serve as the information highway interconnecting the other illustrated components of the hardware. A processing system 1154 labeled CPU (central processing unit) (e.g., one or more computer processors), can perform calculations and logic operations required to execute a program. A non-transitory computer-readable storage medium, such as read only memory (ROM) 1156 and random access memory (RAM) 1158, can be in communication with the processing system 1154 and can contain one or more programming instructions. Optionally, program instructions can be stored on a non-transitory computer-readable storage medium such as a magnetic disk, optical disk, recordable memory device, flash memory, or other physical storage medium. Computer instructions can also be communicated via a communications signal, or a modulated carrier wave, e.g., such that the instructions can then be stored on a non-transitory computer-readable storage medium.

A disk controller 1160 interfaces one or more optional disk drives to system bus 1152. These disk drives can be external or internal floppy disk drives 1162, external or internal CD-ROM, CD-R, CD-RW or DVD drives 1164, or external or internal hard drives 1166. As indicated previously, these various disk drives and disk controllers are optional devices. Each of the element managers, real-time data buffer, conveyors, file input processor, database index shared access memory loader, reference data buffer, and data managers can include a software application stored in one or more of the disk drives connected to the disk controller 1160, the ROM 1156 and/or the RAM 1158. Preferably, the processor 1154 can access each component as required.

A display interface 1168 can permit information from the bus 1156 to be displayed on a display 1170 in audio, graphic, or alphanumeric format. Communication with external devices can optionally occur using various communication ports 1172. In addition to the standard computer-type components, the hardware can also include data input devices, such as a keyboard 1172, or other input device 1174, such as a microphone, remote control, pointer, mouse, touchscreen and/or joystick.

Portions of what is described above may be implemented with logic circuitry such as a dedicated logic circuit or with a microcontroller or other form of processing core that executes program code instructions. Thus processes described above can be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The disclosure also relates to an apparatus for performing the operations described herein. This apparatus may be specially constructed for the required purpose, or it may comprise a general-purpose device selectively activated or reconfigured by a computer program stored in the device. Such a computer program may be stored in a non-transitory computer readable storage medium, such as, but not limited to, any type of disk including floppy disks, optical disks, CD-ROMs, and magnetic-optical disks, DRAM (volatile), flash memory, read-only memories (ROMs), RAMs, EPROMs, EEPROMs, magnetic or optical cards, or any type of media suitable for storing electronic instructions, and each coupled to a device bus.

A machine-readable medium includes any mechanism for storing information in a form readable by a machine (e.g., a computer or any of its components such as a microprocessor). For example, a non-transitory machine-readable medium includes read only memory (“ROM”); random access memory (“RAM”); magnetic disk storage media; optical storage media; flash memory devices; etc.

An article of manufacture can be used to store program code. An article of manufacture that stores program code may be embodied as, but is not limited to, one or more non-transitory memories (e.g., one or more flash memories, random access memories (static, dynamic, or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)) and then stored in non-transitory memory (e.g., DRAM or flash memory or both) in the client computer.

The above description of embodiments is not intended to be exhaustive or to limit the invention to the described forms. Specific embodiments of, and examples for, the invention are described herein for illustrative purposes, but various modifications are possible that yield embodiments not described above that are nonetheless within the scope of the invention.

What is claimed is:

1. A non-transitory machine-readable medium storing executable instructions which when executed by a data processing system cause the data processing system to perform a method comprising:
receiving a geometry of a design space for a design of a physical object based on one or more design parameters, a design objective, and design constraints;
performing a plurality of topology optimizations according to the design objective and constraints to generate two or more structure configurations within the design space of the geometry based on two or more sets of values of the design parameters, each structure configuration corresponding to a respective set of values of the design parameters;
generating a nD-ROM (reduced order model) of the scalar field generated by topology optimization in order to predict each of the two or more structure configurations from a corresponding set of the design parameters;
receiving a separate set of values of the design parameters; and
invoking the nD-ROM to predict a target structure configuration within the design space of the geometry from the separate set of values of the design parameters, the target structure configuration for building or manufacturing the physical object.

2. The non-transitory machine-readable medium of claim 1 wherein the geometry of the design space is fixed.

3. The non-transitory machine-readable medium of claim 1 wherein the target structure configuration is obtained by applying a geometric operator to an optimized topology scalar field predicted by the nD-ROM.

4. The non-transitory machine-readable medium of claim 3 wherein applying the geometric operator comprises:
thresholding the optimized topology to eliminate values of a topology scalar field that are outside a specified range;
extracting the target structure configuration from the design space using the thresholded topology scalar field.

5. The non-transitory machine-readable medium of claim 4 wherein extracting the target structure configuration comprises subtracting from the design space parts of the geometry where the topology scalar field is outside the specified range.

6. The non-transitory machine-readable medium of claim 3 wherein the nD-ROM receives the separate set of values of the design parameters from a user interface.

7. The non-transitory machine-readable medium of claim 3 wherein the method further comprises displaying the optimized topology, the target structure configuration, or both, to a user via the user interface.

8. The non-transitory machine-readable medium of claim 1 wherein the two or more sets of values of the design parameters used for the topology optimizations are selected using a design of experiment (DoE) method.

9. The non-transitory machine-readable medium of claim 8 wherein the DoE method is a stochastic DoE method or a deterministic DoE method.

10. The machine-readable medium of claim 1, further comprising:
invoking the nD-ROM to predict an alternative structure configuration within the design space of the geometry from an alternative set of values of the design parameters; and
selecting the target structure configuration for building or manufacturing the physical object.

11. A computer-implemented method comprising:
receiving a geometry of a design space for a design of a physical object based on one or more design parameters, a design objective, and design constraints;
performing a plurality of topology optimizations according to the design objective and constraints to generate two or more structure configurations within the design space of the geometry based on two or more sets of values of the design parameters, each structure configuration corresponding to a respective set of values of the design parameters;
generating a nD-ROM (reduced order model) of the scalar field generated by topology optimization in order to predict each of the two or more structure configurations from a corresponding set of the design parameters;
receiving a separate set of values of the design parameters; and
invoking the nD-ROM to predict a target structure configuration within the design space of the geometry from the separate set of values of the design parameters, the target structure configuration for building or manufacturing the physical object.

12. The computer-implemented method of claim 11 wherein the geometry of the design space is fixed.

13. The computer-implemented method of claim 11 wherein the target structure configuration is obtained by applying a geometric operator to an optimized topology scalar field predicted by the nD-ROM.

14. The computer-implemented method of claim 13 wherein applying the geometric operator comprises:
thresholding the optimized topology to eliminate values of a topology scalar field that are outside a specified range;
extracting the target structure configuration from the design space using the thresholded topology scalar field.

15. The computer-implemented method of claim 14 wherein extracting the target structure configuration comprises subtracting from the design space parts of the geometry where the topology scalar field is outside the specified range.

16. The computer-implemented method of claim 13 wherein the nD-ROM receives the separate set of values of the design parameters from a user interface.

17. The computer-implemented method of claim 13 wherein the method further comprises displaying the optimized topology, the target structure configuration, or both, to a user via the user interface.

18. The computer-implemented method of claim 11 wherein the two or more sets of values of the design parameters used for the topology optimizations are selected using a design of experiment (DoE) method.

19. The computer-implemented method of claim 18 wherein the DoE method is a stochastic DoE method or a deterministic DoE method.

20. The computer-implemented method of claim 10, further comprising:
invoking the nD-ROM to predict an alternative structure configuration within the design space of the geometry from an alternative set of values of the design parameters; and
selecting the target structure configuration for building or manufacturing the physical object.
